(19) United States
(12) Patent Application Publication
(10) Pub. No.: US 2013/0239710 A1
(43) Pub. Date: Sep. 19, 2013

(54) Fixed Joint Boot Test Fixture Assembly

(71) Applicants: Russell L. Dusett, JR., Casco, MI (US); Michael Ross, Metamora, MI (US); David G. Sasseen, Lapeer, MI (US); Gary D. Grabaum, Rochester Hills, MI (US)

(72) Inventors: Russell L. Dusett, JR., Casco, MI (US); Michael Ross, Metamora, MI (US); David G. Sasseen, Lapeer, MI (US); Gary D. Grabaum, Rochester Hills, MI (US)

(73) Assignee: GKN DRIVELINE NORTH AMERICA, INC., Auburn Hills, MI (US)

(21) Appl. No.: 13/420,096

(22) Filed: Mar. 14, 2012

(51) Int. Cl. G01D 11/30

(52) U.S. Cl. CPC G01D 11/30
USPC 73/866.5

(57) ABSTRACT

A fixed joint test fixture is disclosed that may be selectively assembled and disassembled. The fixed joint test fixture includes a fixed joint sub-assembly, a shaft member, and a selectively actuatable engagement member. The fixed joint sub-assembly includes an inner bore and a stem member with a channel extending therethrough. The shaft member has an engagement channel formed in an end surface of an engagement end thereof. The engagement member is configured to be received within the engagement channel. The engagement end of the shaft is configured to be received within the inner bore, with the engagement member partially seated within the engagement channel thereof. The engagement member is configured to be advanced from the partially seated position within the engagement channel, thereby causing the shaft member to selectively and frictionally engage with the fixed joint sub-assembly.

### TECHNICAL FIELD

The disclosure relates to improvements to test fixturing components used in testing sealing boots and clamping designs.

### BACKGROUND

Components for a driveline of a vehicle undergo numerous tests to evaluate the designs. Such testing necessarily involves the fabrication of test fixtures to replicate the operation conditions of the vehicle onto which the components will be mounted. An example of one such component that undergoes routine testing is a boot for driveline assemblies.

However, after testing, it has been found that current boot test fixtures are often unusable after removal of the boot from the test fixture because the test fixture design does not facilitate easy separation or disassembly of the boot from the fixed joint components. As such, the fixture components become damaged. Moreover, for components that have painted surfaces, the painted surfaces are often damaged during boot removal. As it is sometimes necessary to clean the fixed joint components of a test fixture or add new grease for the components to complete testing, the inability to easily dissemble the boot from the test fixture without causing damage is problematic. Indeed, currently, when disassembly of a boot from the test fixture causes damage to the fixture, a new test fixture must be fabricated to continue with boot tests. However, each test fixtures takes two-three hours to rebuild and requires additional raw material for the components to be manufacture, thereby increasing testing costs. Further delays in completing testing are experienced to allow for re-fabrication of test components.

What is needed is a testing fixture design that permits disassembly of the boot from the test fixture components, without causing damage to those components. A test fixture design that improves the ease of disassembly is also desirable, so as to improve timing of testing.

### SUMMARY

A fixed joint test fixture is disclosed that may be selectively assembled and disassembled. The fixed joint test fixture includes a fixed joint sub-assembly, a shaft member, and a selectively actuatable engagement member. The fixed joint sub-assembly includes an inner bore and a stem member with a channel extending therethrough. The shaft member has an engagement channel formed in an end surface of an engagement end thereof. The engagement member is configured to be received within the engagement channel. The engagement end of the shaft is configured to be received within the inner bore, with the engagement member partially seated within the engagement channel thereof. The engagement member is configured to be advanced from the partially seated position within the engagement channel, thereby causing the shaft member to selectively and frictionally engage with the fixed joint sub-assembly.

In one exemplary configuration, the engagement member is a tapered plug that may be advanced in a tapered channel. Relief grooves extend radially outward from the tapered channel. The relief channels expand as the tapered plug is advanced within the tapered channel, thereby causing the shaft to frictionally engage the inner bore of the fixed joint sub-assembly.

In another exemplary configuration, the engagement member is a fastener assembly that includes a bolt and a washer. The fastener assembly cooperates with a compressible member to assist in frictionally engaging the shaft within the bore of the fixed joint sub-assembly. As the bolt is advanced into the engagement channel, the washer compressible compressible member such that material is compressed around an end surface of the shaft and within the bore, thereby frictionally retaining the shaft within the bore.

In one exemplary arrangement, the channel of the stem member is configured to receive a tool that may be utilized to selectively advance the engagement member within the engagement channel.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 is an exploded elevational view of a test fixture design.

FIG. 2 is an elevational view of the test fixture design of FIG. 1, being assembled.

FIG. 3 is a partially exploded elevational view of the test fixture design of FIG. 1, illustrating sealing of the test fixture after assembly.

FIG. 4 is an exploded elevational view of an alternative test fixture design.

FIG. 5 is a partially exploded elevational view of the test fixture design of FIG. 4, partially assembled.

FIG. 6 is an elevational view of the test fixture design of FIG. 4, being assembled.

FIG. 7 is a partially exploded elevational view of the test fixture design of FIG. 4, illustrating sealing of the test fixture after assembly.

### DETAILED DESCRIPTION

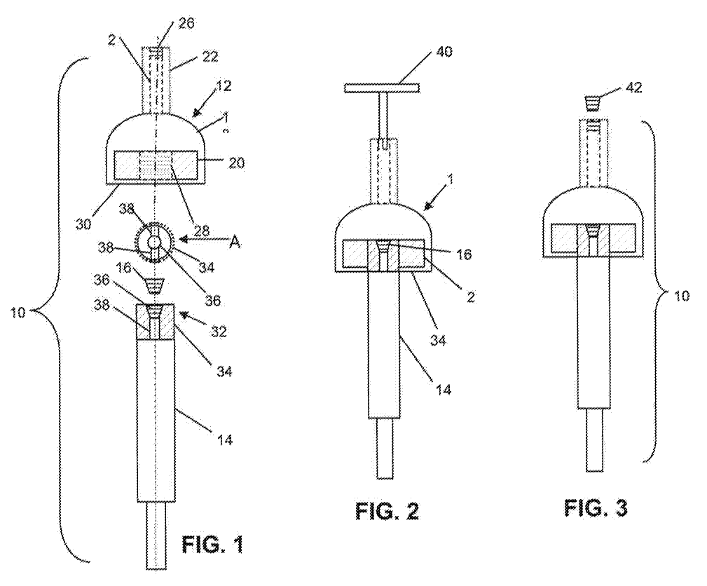

Referring to the drawings, FIGS. 1-3 illustrate a first exemplary arrangement of a fixed joint boot fixture assembly 10 that is used to test sealing systems, such as boots and clamps (not shown), used with a fixed joint. Fixture assembly 10 includes a fixed joint assembly 12 and a shaft 14. A plug member 16 is used to operatively connect fixed joint assembly 12 to shaft 14, as will be explained in further detail below.

Fixed joint assembly 12 includes an outer joint part 18 and an inner joint part 20 secured therein in a conventional manner. Outer joint part 18 includes a bore or cavity into which inner joint part 20 is received. A stem 22 is attached to outer joint part 18. A channel 24 is formed through stem 22 and is configured to open into the bore of outer joint part 18. As may be seen, channel 24 includes an opening 26 that is formed through an end of stem 22, to be discussed in further detail below. Access to the bore of outer joint part 18 is advantageous to permit access thereto without requiring complete disassembly of fixed joint 12, such as, for example, adding lubricant.

Inner joint part 20 is arranged within the bore of outer joint part 18. Inner joint part 20 includes an inner joint bore 28 that includes a plurality of splines 30 to facilitate engagement with shaft 14. A ball cage (not shown) is also arranged within the bore of outer joint part 18 in a convention manner, with inner joint part 20 being positioned within the cage.

Shaft 14 is configured with an engagement end 32. Engagement end 32 is configured with a splined outer surface 34 that is configured to be received within inner joint bore 28 and engage with splines 30. Engagement end 32 includes a tapered channel 36 configured to received plug member 16. As seen in the end view A of shaft 14, engagement end 32 further includes relief grooves 38. Relief grooves 38 extend radially outward from tapered channel 36 so as to intersect the splined outer surface 34 of engagement end 32. While the embodiment depicted in FIG. 1 (inset A) illustrates two relief grooves 38, it is understood that additional relief grooves may be provided, including, but not limited to four, or six relief grooves. Relief grooves 38 may be arranged equi-distant from one another. Relief grooves 38 are configured to selectively expand from a relaxed configuration whereby relief grooves 38 have a first defined width to an expanded configuration whereby relief grooves 38 have a second defined width that is greater than the first defined width. An outer diameter of engagement end 32 is configured to expand when relief grooves are in the expanded configuration, as will be explained in further detail below.

Referring to FIGS. 2-3, assembly of fixture assembly 10 will now be described. Plug member 16, which is sized to be slightly larger than tapered channel 36, is partially inserted into tapered channel 36 of shaft 14. In this configuration, relief grooves 38 are in the relaxed configuration. With plug member 16 partially seated within tapered channel 36, engagement end 32 of shaft 14 is inserted into a pre-assembled fixed joint assembly 12. More specifically, engagement end 32 is inserted into the bore of inner joint part 20, which is preassembled within outer joint part 18.

Next, a tool 40 is inserted through opening 26 of stem 22 and extended through channel 24. Tool 40 is configured to operatively engage with plug member 16. In one exemplary arrangement, tool 40 is a hex key. Tool 40 is utilized to seat plug member 16 within tapered channel 36. As hex key is operated, because plug member 16 is larger than tapered channel 36, as plug member 16 is seated within tapered channel 36, relief grooves 38 are expanded into the expanded configuration. The expanded configuration of relief grooves 38 operate to expand engagement end 32 of shaft 14, thereby creating a frictional engagement between splined outer surface 34 of shaft 14 and splines 30 of the bore of inner joint part 20. Once plug member 16 is fully seated and shaft 14 is frictionally engaged with fixed joint assembly 12, tool 40 is removed from stem 22 and a sealing plug 42 may be positioned in opening 26 to seal fixed joint assembly 12. In one exemplary configuration, both sealing plug 42 and opening 26 are threaded such that plug 42 may be engaged with opening 26 in a threaded engagement.

Fixture assembly 10 may also be easily disassembled by reversing the above described steps. More specifically, to disassemble fixture assembly 10, sealing plug 42 is removed from opening 26, thereby opening channel 24. Tool 40 is reinserted into channel 24 and operatively engages with plug member 16. Tool 40 is then operated to at least partially release plug member 16 from tapered portion 36. When sufficiently released such that the relief grooves 36 are returned to the relaxed configuration, shaft 14 is disengaged with fixed joint assembly 12.

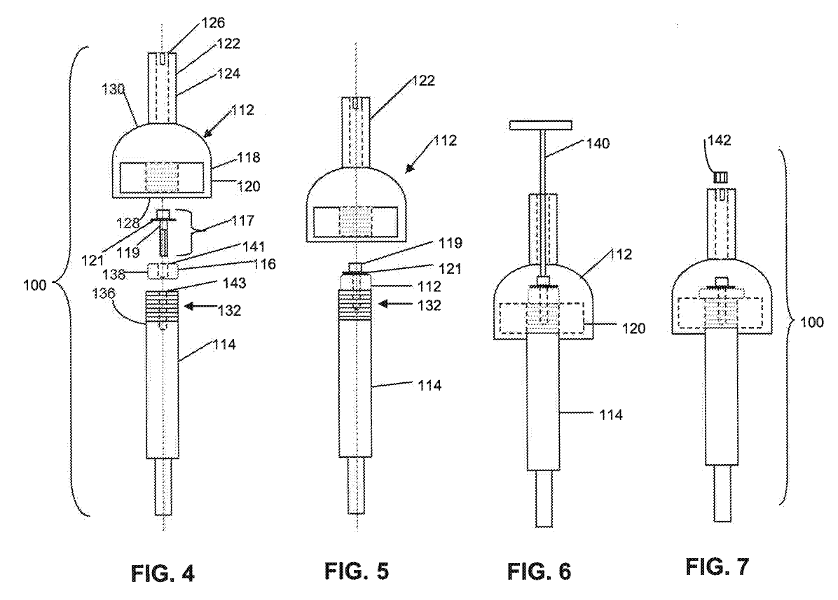

An alternative embodiment of a fixture assembly 100 is shown in FIGS. 4-7. Fixture assembly 100 includes a fixed joint assembly 112 and a shaft 114. A compressible member 116 that cooperates with a fastening assembly 117 is used to operatively connect fixed joint assembly 112 to shaft 114, as will be explained in further detail below.

Fixed joint assembly 112 includes an outer joint part 118 and an inner joint part 120 secured therein in a conventional manner. Outer joint part 118 includes a bore or cavity into which inner joint part 120 is received. A stem 122 is attached to outer joint part 118. A channel 124 is formed through stem 122 and is configured to open into the bore of outer joint part 118. As may be seen, channel 124 includes an opening 126 that is formed through an end of stem 122, to be discussed in further detail below. Access to the bore of outer joint part 118 is advantageous to permit access thereto without requiring complete disassembly of fixed joint 112, such as, for example, adding lubricant.

Inner joint part 120 is arranged within the bore of outer joint part 118. Inner joint part 120 includes an inner joint bore 128 that includes a plurality of splines 130 to facilitate engagement with shaft 114. A ball cage (not shown) is also arranged within the bore of outer joint part 118 in a convention manner, with inner joint part 120 being positioned within the cage.

Shaft 114 is configured with an engagement end 132. Engagement end 132 is configured with a splined outer surface 134 that is configured to be received within inner joint bore 128 and engage with splines 130. Engagement end 132 includes an engagement channel 136 configured to receive a portion of fastening assembly 117. More specifically, in one exemplary arrangement, fastening assembly 117 comprises a shoulder bolt 119 and a washer 121. An engagement end of shoulder bolt 119 is configured to be received within engagement channel 136. In one exemplary arrangement, engagement channel 136 is configured with threads that operatively engage with threads on shoulder bolt 119.

Compressible member 116 is constructed of any suitable compressible material. A mounting channel 138 is formed through compressible member 116. Mounting channel 138 has a diameter that is sized to receive shoulder bolt 119 such that shoulder bolt 119 extends through compressible member 116. However, the diameter of mounting channel 138 is sized to be smaller than an outer diameter of washer 121 such that washer 121 engages a top surface 141 of compressible member 116, as will be explained in further detail below. Compressible member 116 is further sized to have an outer diameter that corresponds to the inner diameter of inner joint bore 128.

Referring to FIGS. 5-6, assembly of fixture assembly 100 will now be described. Compressible member 116 is positioned against an end surface 143 of engagement end 132, with mounting channel 138 aligned with engagement channel 132. With washer 121 assembled to shoulder bolt 119, shoulder bolt is inserted through mounting channel 138 and partially inserted into engagement channel 132 such that fastening assembly 117 and compressible member 116 are loosely assembled to shaft 114, as shown in FIG. 5.

Next, turning to FIG. 6, engagement end 132 of shaft 114 is inserted into a pre-assembled fixed joint assembly 112. More specifically, engagement end 132 is inserted into the bore of inner joint part 120, which is preassembled within outer joint part 118. Because compressible member 116 is sized to have an outer diameter that generally corresponds with the diameter of inner joint bore 128, a portion of compressible member 116 extends through inner joint bore 128.

Once shaft 114 is seated within inner joint bore 128, a tool 140 is inserted through opening 126 of stem 122 and extended through channel 124. Tool 140 is configured to operatively engage with shoulder bolt 119. In one exemplary arrangement, tool 140 is a hex key, though it is appreciated that other suitable tools may be utilized. Tool 140 is actuated to seat shoulder bolt 119 within engagement channel 132. As tool 140 is operated, because compressible member 116 is positioned between end surface 143 of engagement end 132 of shaft 114 and washer 121, as shoulder bolt 119 advances into engagement channel 136, compressible member 116 becomes compressed partially within inner joint bore 128 and around engagement end 132, thereby selectively and frictionally engaging shaft 114 to fixed joint assembly 112, as best seen in FIG. 7.

Once shoulder bolt 119 is seated within engagement channel 132 and shaft 114 is frictionally engaged with fixed joint assembly 112, tool 140 is removed from stem 122 and a sealing plug 142 may be positioned in opening 126 to seal fixed joint assembly 112. In one exemplary configuration, both sealing plug 142 and opening 126 are threaded such that plug 142 may be engaged with opening 126 in a threaded engagement.

Fixture assembly 100 may also be easily disassembled by reversing the above described steps. More specifically, to disassemble fixture assembly 100, sealing plug 142 is removed from opening 126, thereby opening channel 124. Tool 140 is reinserted into channel 124 and operatively engages with shoulder bolt 119. Tool 140 is then operated to at least partially release shoulder bolt 119 from engagement channel 132, thereby releasing compressible member 116 from it compressed state. When sufficiently released, compressible member 116 returns to its original diameter that corresponds to the inner diameter of inner joint bore 128 such that shaft 114 may be easily disengaged from fixed joint assembly 112.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A fixed joint test fixture, comprising:
a fixed joint sub-assembly including an inner bore and a stem member with a channel extending therethrough;
a shaft member having an engagement channel formed in an end surface of an engagement end thereof; and
a selectively actuatable engagement member that is configured to be received within the engagement channel;
wherein the engagement end of the shaft is configured to be received within the inner bore, with the engagement member partially seated within the engagement channel thereof;
wherein the engagement member is configured to be advanced from the partially seated position within the engagement channel, thereby causing the shaft member to frictionally and selectively engage with the fixed joint sub-assembly.

2. The fixed joint test fixture of claim 1, wherein the engagement channel is tapered and the engagement member is a tapered plug that is sized to be slightly larger than the tapered channel.

3. The fixed joint test fixture of claim 2, further comprising a plurality of relief grooves formed in the engagement end of the shaft, wherein the relief grooves extends radially outward from the engagement channel and intersect with an outer surface of the engagement end.

4. The fixed joint test fixture of claim 3, wherein the relief channels are spaced equi-distant from one another.

5. The fixed joint test fixture of claim 3, wherein the relief channels are selectively configurable between a relaxed configuration and an expanded configuration, wherein the relief channels are in the relaxed configuration when the plug member is in the partially seated positioned and wherein the relief channels are in the expanded configuration when the plug member is advanced into the tapered channel.

6. The fixed joint test fixture of claim 1, wherein the fixed joint sub-assembly further comprises an outer joint part having a bore therein and an inner joint part that is received within the bore of the outer joint part.

7. The fixed joint test fixture of claim 6, wherein the channel of the stem member is in communication with the bore of the outer joint part.

8. The fixed joint test fixture of claim 7, wherein the channel of the stem member is configured to receive a tool member that operatively and selectively advances the engagement member within the engagement channel to facilitate the frictional engagement of the shaft member to the inner joint part of the fixed joint sub-assembly.

9. The fixed joint test fixture of claim 1, further comprising a compressible member having a mounting channel therethrough, wherein the compressible member is positioned against the end surface of the engagement end of the shaft and the engagement member is extended through the mounting channel so as to be partially seated within the engagement channel in an uncompressed, assembly configuration.

10. The fixed joint test fixture of claim 9, wherein the engagement member comprises a bolt and a washer, wherein the washer is mounted to the bolt before the bolt is inserted through the mounting channel and partially seated within the engagement channel such that the compressible member is disposed between the end surface of the shaft and a bottom surface of the washer.

11. The fixed joint test fixture of claim 10, wherein the compressible member is configured with an outer diameter in an uncompressed configuration that corresponds with the inner diameter of the bore such that the compressible member may be partially extended through the bore when the engagement shaft is received within the bore.

12. The fixed joint test fixture of claim 11, wherein the bolt is configured to be advanced into the engagement channel when the engagement shaft is positioned within the bore, whereby advancement of the bolt causes the compressible member to move from the uncompressed configuration to a compressed configuration as the washer exerts a compressive forced on the compressible member, wherein in the compressed configuration, a portion of compressible member is received within the bore and around the end surface of the engagement end of shaft, thereby frictionally retaining the shaft to the fixed joint sub-assembly.

13. The fixed joint test fixture of claim 10, wherein the channel of the stem member is configured to receive a tool member that operatively and selectively advances the bolt within the engagement channel to facilitate the frictional engagement of the shaft member within the bore of the fixed joint sub-assembly.

14. The fixed joint test fixture of claim 1 further including a sealing plug that is selectively seals an opening to the channel of the stem member.

15. The fixed joint test fixture of claim 1, wherein the bore of the fixed joint sub-assembly is splined.

16. The fixed joint test fixture of claim 15, wherein the engagement surface of the shaft includes splines on an outer surface thereof.
